(19) United States
(12) Patent Application Publication
(10) Pub. No.: US 2003/0019884 A1
(43) Pub. Date: Jan. 30, 2003

(54) Container for dispensing ice confections

(76) Inventors: Jesus San Martin, Esplugues de Llobregat (ES); Jorge Bueno Ceresuela, Sant Quirze Del Valles (ES)

Correspondence Address: WINSTON & STRAWN, PATENT DEPARTMENT, 1400 L STREET, N.W., WASHINGTON, DC, 20005-3502, US

(21) Appl. No.: 10/206,090

(22) Filed: Jul. 25, 2002

Related U.S. Application Data
(63) Continuation of application No. PCT/EP00/08165, filed on Aug. 17, 2000.

(30) Foreign Application Priority Data
Jan. 26, 2000 (ES) U 200000160

(51) Int. Cl. G01F 11/00

(52) U.S. Cl. 222/1

(57) ABSTRACT

An improved container for ice confectioneries particularly for use in dispensing equipment, of the type having a cylindrical or prismatic body, and preferably made from cardboard, in which the body has protrusions for preventing frost or ice that forms on its outer surface from causing adjacent, stacked containers from sticking together, thus enabling proper dispensing of the containers from automated dispensing or vending machines.

### CROSS-REFERENCE TO RELATED APPLICATIONS

This application is a continuation of the U.S. national stage designation of International application PCT/EP00/08165 Filed Aug. 17, 2000, the entire content of which is expressly incorporated herein by reference thereto.

### TECHNICAL FIELD

The present application is directed to an improved container for ice confectionery articles that can be used in dispensing equipment comprising freezer cabinets and vending machines. These containers incorporate noteworthy innovations and advantages compared with current containers and objects for similar purposes.

More specifically, the container of the invention is especially made of cardboard, and is intended to hold ice confectioneries and be suitable for use in dispensing equipment. The container has a series of at least two encircling, low-height ribs distributed over its contour that facilitate detachment of the stacked containers and prevent them from adhering together or adhering to the walls of the dispensing apparatus due to the presence of frost or ice.

### BACKGROUND OF THE INVENTION

There are currently a variety of types of machines for automatically dispensing food products and beverages on the market. Common among these type machines are those that arrange the product containers in columns in order to dispense them under gravity. These containers are generally metallic and their temperature never reaches freezing point, with the result that supplying them individually creates no problems.

Hitherto, there has been no known automatic dispensing of ice confectionery contained in containers that allow them to be supplied individually under gravity. Unlike currently known containers, these containers have to be at temperatures below freezing point so that the contents maintain their frozen form. Maintaining such low temperatures causes frost and ice to form inside the machines and become deposited on the containers. When the containers are formed of cardboard, it is possible for the containers to adhere to one another and to the contact walls, making their detachment and individual supply difficult or impossible. It is precisely this drawback that the container of the present invention aims to overcome.

### SUMMARY OF THE INVENTION

The present invention relates to a container for dispensing an ice confectionery from dispensing equipment that is maintained at temperatures below freezing. The container includes a body that is configured and dimensioned to retain an ice confectionery therein. This body has a wall with an outer surface that includes protruding means for limiting surface contact with adjacent containers. Thus, frost or ice that forms on the outer surface of the wall cannot contact that of adjacent containers, thus preventing the containers from sticking together and hindering proper delivery of the container from the dispensing equipment.

The protruding means preferably comprises at least two outer surface encircling ribs which are operationally arranged in order to form small areas of contact between stacked containers. Also, the body preferably has a cylindrical or prismatic shape, and is made from cardboard.

Advantageously, the container has a tear-off opening strip for gaining access to the ice confectionery therein. This strip preferably comprises two encircling weakened lines located on one side.

The containers are utilized in a dispensing apparatus which comprises a cabinet maintained at temperatures below freezing, a plurality of the inventive containers, each containing an ice confection therein, and a column for stacking the containers and dispensing them by gravity force. The apparatus is preferably in the form of an automatic vending machine.

### BRIEF DESCRIPTION OF THE DRAWINGS

In order to supplement the description which will be given below and in order to aid better comprehension of the characteristics of the present invention, the present description is accompanied by a set of drawings whose figures show the most significant details of the invention in an illustrative and non-limiting manner, and wherein:

FIG. 1 shows a perspective view of the container; and

FIG. 2 shows a view of two stacked containers.

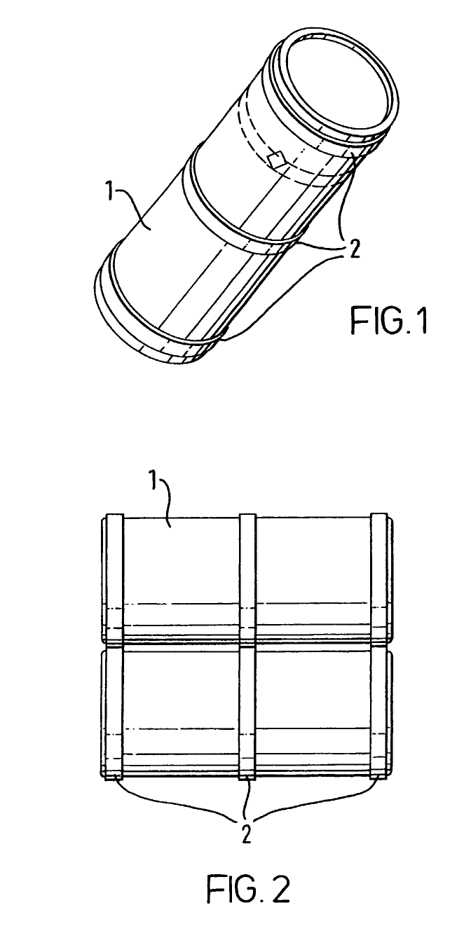

### DETAILED DESCRIPTION OF THE PREFERRED EMBODIMENTS

The improved container for ice confectionery for dispensing equipment, which is the subject of the present invention, is characterized in that it comprises a body of regular shape, such as a cylindrical or prismatic shape, which has means for preventing the formation of frost or ice on its surface from sticking to adjacently positioned containers. Thus, as the sticking area is small, it can easily be broken so as to not impair the movement of the containers in e.g., a vending machine.

In the context of the invention articles of ice confectionery mean portions of ice cream, water ice, sherbet, sorbet in the form of sticks, cylinders, sandwiches, bars, morsels or cones.

Correct storage of ice confectionery actually requires the storage receptacle to be held at a temperature that is considerably below the freezing temperature. At this temperature, water vapor in the air easily freezes, forming a layer of frost that covers all exposed surfaces. This layer of frost can become quite thick, but the main problem posed is that it can join the surface of bodies via their points of contact. Ice confectionery containers, which are normally stacked, may then be joined by a frost connection in the areas where they are in contact, thus hindering proper dispensing of such containers.

In order to prevent this effect, the invention has made provisions for the existence of a series of ribs or low reliefs encircling the containers. Indeed, the containers, which are normally stacked on their side inside the machine, are in contact only via the aforesaid ribs, with this significantly reducing the surface area in mutual contact. As the contact points are of significantly reduced surface area, the frost exerts an adhesive power that is also reduced, and which adhesion is easily broken or overcome through the effect of gravity or slight vibration.

Provision has also been made for the container to have, near one end, a weakened encircling double line which, together with a tear-off tab located at a specific point along its length, forms an opening means for the container so that the consumer can access the ice confectionery product that is dispensed in the container.

In the light of the aforesaid figures and in accordance with the numbering adopted it is possible to see therein a preferred but non-limiting embodiment of the invention, which consists of a preferably cylindrical body (1) which has, distributed over its contour, a series of encircling ribs (2), two encircling weakened lines being located on one side and configuring a tear-off opening strip.

What is claimed is:

1. A container for dispensing an ice confectionery from dispensing equipment that is maintained at temperatures below freezing, which comprises a body which is configured and dimensioned to retain an ice confectionery therein, the body having an wall with an outer surface that includes protruding means for limiting surface contact with adjacent containers so that frost or ice that forms on the outer surface of the wall cannot contact that of adjacent containers, thus preventing the containers from sticking together and hindering proper delivery of the container from the dispensing equipment.

2. The container of claim 1 wherein the protruding means comprises at least two outer surface encircling ribs which are operationally arranged in order to form small areas of contact between stacked containers.

3. The container of claim 1 wherein the body has a cylindrical or prismatic shape.

4. The container of claim 1 made from cardboard.

5. The container of claim 1, which further comprises a tear-off opening strip for gaining access to the ice confectionery.

6. The container of claim 5, wherein tear-off opening strip comprises two encircling weakened lines located on one side.

7. An ice confectionery dispensing apparatus which comprises a cabinet maintained at temperatures below freezing, a plurality of the containers of claim 1 each containing an ice confection therein, and a column for stacking the containers and dispensing them by gravity force.

8. The apparatus of claim 7, in the form of an automatic vending machine.
